(19) United States
(12) Patent Application Publication
(10) Pub. No.: US 2018/0332028 A1
(43) Pub. Date: Nov. 15, 2018

(54) Method For Detecting Unauthorized Copies Of Digital Security Tokens

(71) Applicant: Deutsche Post AG, Bonn (DE)

(72) Inventors: Harald Lemke, Hamburg (DE); Mike Bobinski, Bonn (DE); Steven Engelhard, Euskirchen (DE)

(21) Appl. No.: 15/889,377

(22) Filed: Feb. 6, 2018

(30) Foreign Application Priority Data
Feb. 7, 2017 (DE) 10 2017 102 336.4

(51) Int. Cl. H04L 29/06; G06F 21/32; H04L 9/08

(52) U.S. Cl. CPC H04L 63/0807; H04L 63/06; H04L 9/0816; G06F 21/32

(57) ABSTRACT

A method for operating a digital security token in a data network terminal (12) includes provisioning the digital security token in the data network terminal (12), examining a test characteristic (Pz) with a server (14) based on information about the test characteristic (Pz) and a connection of the test characteristic (Pz) to a user (C) in the context of the use of the digital security token for authenticating the user (C) and/or in the context of a periodic routine examination, and transmitting a new test characteristic (Pz) from the server (14) to the data network terminal (12) only if the examined test characteristic (Pz) is accurate. The new test characteristic (Pz) is necessary for continued operation of the digital security token.

### CROSS-REFERENCE TO RELATED APPLICATIONS

This application is related and claims priority to DE 10 2017 102 336.4, which is hereby incorporated by reference in its entirety for all purposes.

### FIELD OF THE INVENTION

The invention relates generally to a method of operating a digital security token in a data network terminal, wherein the digital security token serves for authentication of a user who is using the data network terminal. The invention also relates generally to a data network terminal with a digital security token which is used for authenticating a user who is using the data network terminal and has a test characteristic, which is stored in the data network terminal such that it is protected against unauthorized access by a user code.

### BACKGROUND OF THE INVENTION

Electronic identities are becoming increasingly important, in particular if such identities can be derived from forgery-proof official identity documents. Many existing variants of electronic identities are managed centrally on a server and are constantly exposed to the threat of unauthorized access and identity theft. The use of an electronic identity is always associated with authentication of the user against the storage medium of the user's identity. A high level of authentication requires protective measures against unauthorized use and unauthorized copying of the identity, usually a two-factor protection by combining authentication features from two different areas of “possessions”, “knowledge” and “biometric features”.

A copy-protected possession usually gives rise to solutions with special hardware security tokens, such as a chip card, which require particular technical conditions for possible use and have only low levels of acceptance. A pure coupling of the identity to existing hardware, as in the case of the widespread mTAN solution by coupling to the SIM card of a mobile phone, is problematic for joint usage, loss and exchange. In addition, there are several attack scenarios on the processes of the mobile network provider that can lead to a copy of the SIM card being obtained by unauthorized persons. In the context of this patent application, a security token is defined as a hardware and/or software component for identification and authentication of users.

A secured digital security token, which can be stored under direct control on existing, in particular mobile, terminal devices would be ideal. Digital tokens do not allow effective protection against unauthorized copying, however. If the identity data is only stored locally on the users' terminals, then an identity theft by an attacker only affects at least the individual identities directly affected and does not automatically affect all users of the identity service.

### SUMMARY OF THE INVENTION

Aspects and advantages of the invention will be set forth in part in the following description, or may be apparent from the description, or may be learned through practice of the invention.

An object of the invention is to provide a method of operating a security token in a terminal, as well as a corresponding terminal, which increases security.

In the method of operating a digital security token in a data network terminal, in which the security token is used for authenticating a user who is using the data network terminal, the method has the following steps:

(i) provision of the security token in the data network terminal, wherein the security token has a test characteristic, which is stored in the data network terminal and protected by a user code against unauthorized access, and wherein information about the test characteristic and the connection of the test characteristic to the data network terminal device is stored in a server integrated into the data network;

(ii) examination of the test characteristic by the server based on the information about the test characteristic and the connection of the test characteristic to the user in the context of the use of the security token for authenticating the user and/or in the context of a periodic routine examination, wherein the server transmits to the data network terminal a new test characteristic which is necessary for the continued operation of the security token only if the examined test characteristic is accurate. The examination of the test characteristic is used to determine whether the security token is being used in the data network terminal legitimately, in other words furnished with an appropriate permission or authorisation. If the existence of the authorization is established, then the existing test characteristic is exchanged for the new test characteristic which is required for the continued operation of the security token.

The core of the invention is the following consideration: Since the unauthorized copy of a security token can never be ruled out, instead of a copy protection a system for detecting copies of the security token is used. The server is a server of an identity service provider.

If the security token with the test characteristic is copied without authorization, the user code stolen and used on another device, then this copy can only be used until the test characteristic is to be changed on the original device. As soon as this point has passed, the unauthorized usage becomes transparent.

If an unauthorized copy were actually to be used in the time window, the usage will be noticeable both to the legitimate user and to the identity service provider which provides the server upon the next cyclic or event-triggered examination by the original device. In this case, the identity service provider can disable the identity, mark all previous identification operations with “there is an increased risk of fraudulent use”, and have them cleared or revoked by the user.

Therefore, it is provided according to a preferred embodiment of the method according to the invention that, in the absence of confirmation of the accuracy of the examined test characteristic by the server, the data network terminal device disables the function of the digital security token and/or informs the user of a possible improper use of the digital security token.

In principle, the digital security token can include both hardware and software components. In accordance with another preferred embodiment of the method according to the invention, however, it is provided that the digital security token is a pure software token. The pure software token is formed, for example, by an application software (app: application software) for the data network terminal. It is advantageously provided that the server has originally transmitted the digital security token provided there to the data network terminal.

In accordance with a preferred form of the invention, the user code is
a password or other confidential piece of information known to the user or
a biometric feature of the user.

In accordance with a preferred configuration of the invention, the test characteristic is a check digit. Check digits are particularly easy to use.

This results in the following scenario, for example: an identity service provider assigns a digital security token with a check digit, which is stored on the data network terminal and protected, for example, by a confidential piece of information, or secret for short. This check digit is checked and replaced by the server of the identity service provider on a cyclical basis and each time it is used, via a secure on-line connection. If the security token with the check digit is copied without authorization, the secret code stolen and used on another device, then this copy can only be used until the check digit is changed on the original device. As soon as this point has passed, the unauthorized usage becomes transparent. If an unauthorized copy were actually to be used in the time window, this will be noticeable both to the legitimate user of the original device and to the identity service provider upon the next cyclic or event-triggered examination by the original device.

The invention also relates to the use of the digital security token operated in accordance with the above-mentioned method for a transaction using the data network terminal. Such transactions are known from online banking, among other services.

The invention also relates to a computer program product including program parts loaded in a computer unit, which are configured for implementing the above-mentioned method.

In the data network terminal with the digital security token, which is used for authenticating a user who is using the data network terminal and has a test characteristic, which is stored in the data network terminal such that it is protected against unauthorized access by a user code, the terminal device is configured
to transmit the test characteristic to the server for examining the test characteristic in the context of the use of the security token for authenticating the user and/or in the context of a periodic routine examination and
to subsequently replace the test characteristic by a new test characteristic received from the server for further operation. The data network device is configured in particular for implementing the method referred to above. It should also be noted once again at this point that the examination of the test characteristic is used for determining whether the security token is being used in the data network terminal legitimately, wherein it is therefore examined whether the security token used is furnished with an appropriate permission or authorization. If as a result of the examination the existence of an authorization is established, then the existing test characteristic is exchanged for a new test characteristic which is required for the continued operation of the security token. Therefore, the data network terminal is a data network terminal with a digital security token, which has an interchangeable test characteristic.

According to a preferred configuration of the data network terminal according to the invention, the latter is configured, in the absence of confirmation of the accuracy of the examined test characteristic by the server, to disable the function of the digital security token and/or to alert the user of a possible improper use of the digital security token.

### FIGURES

In the following, the invention is described in greater detail with reference to the attached drawings and based on preferred embodiments.

Shown are:

FIG. 1 a system for operating a digital security token in a data network device according to a preferred embodiment of the invention;

FIG. 2 a flow diagram of the process for registering the user and for initializing an application software, which forms the digital security token;

FIG. 3 a flow diagram for assigning an ID record by an identification service provider; and

FIG. 4 a flow diagram of a remote identification of the user by an identity recipient.

### DETAILED DESCRIPTION OF FIGURES

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

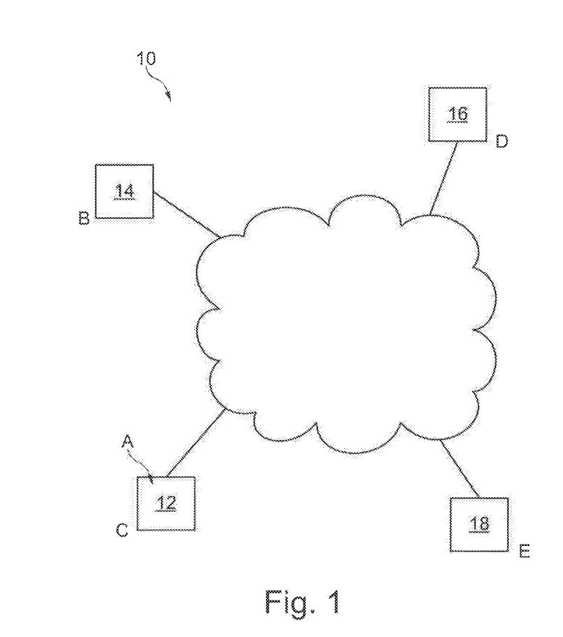

FIG. 1 shows a schematic representation of a system within a data network 10 for operating a digital security token in a data network terminal 12 of a user C which is integrated in the data network 10. The data network 10 can be either a local area network or the internet. In addition to the data network terminal 12, the system also includes a server 14 of an identity provider B, as well as a server 16 of an identification service provider D or identity inspector. Typically, there are two different servers 14, 16 integrated in the data network 10. However, cases in which the two servers are the same are also possible. In addition, a data network terminal 18 of a third party is also indicated, which is a potential identity recipient E with regard to the user of the data network terminal 12.

In the following, various operating situations in connection with the digital security token will be described on the basis of flow diagrams.

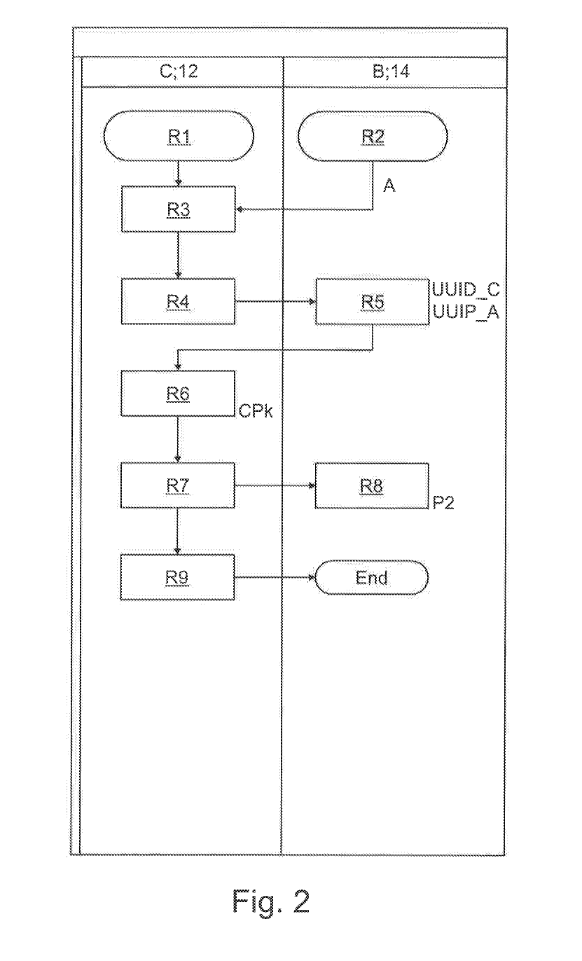

FIG. 2 shows a flow diagram of a registration of the user C, and a configuration of the digital security token having a plurality of steps R1-R9. Here, the actions in the terminal 12 of the user are arranged on the left-hand side and the actions on the server 14 of the identity service provider are on the right-hand side.

The following steps are obtained:

Step R1—The user C first registers with the identity service;

Step R2—A digital security token A is provided as a possession factor by the identity service provider B in the form of an application software (app) A for use by natural persons;

Step R3—the application software (app) A is downloaded by the user C and installed on his/her terminal 12;

Step R4—the initialization is then started;

Step R5—an ID token UUID_C identifying the user C and an ID token UUID_A identifying the installed application software A are assigned by the identity provider B;

Step R6—in the application software A, a public-private key pair CPk is generated as part of the installation on the device 12;

Step R7—the private-key in the application software A is protected by a secret (password) or a biometric feature (for example a fingerprint, iris scan, face recognition, etc.) of the user C (i.e. a user code) supported by the device, and the digital security token is encrypted with the public key CPk and stored on the device 12;

Step R8—a check digit Pz assigned by the identity service provider B is stored on the server 14 of the identity provider B; and

Step R9—this check digit Pz is also stored in the application software A.

The application software or digital security token A has then been successfully installed (End).

2) The application software (app) A communicates exclusively with the identity service provider B over a secure connection (for example SSL) and identifies itself with the UUID_A token.

3) The application software (App) A queries cyclically and/or upon each use of the identity provider B, whether or not the check digit Pz is still correct/valid:
a) If the check digit Pz is correct, the identity service provider B sends back a new check digit Pz as a positive response; or
b) If the check digit is wrong, then the identity provider B sends back an error message and disables the identity.

4) The identification service provider D, the purpose of which is to inspect the identity of a user C, is itself identified before the integration in the system by the identity provider B and receives a specific client software E, which also communicates exclusively with the identity provider B via a secure connection. During the installation of the client software E,
a) an identifying UUID_CLIENT is assigned,
b) a public-private key pair is generated,
c) the public key is stored on the server of the identity service provider B, and
d) a descriptive plain text name is assigned to the UUID_CLIENT.

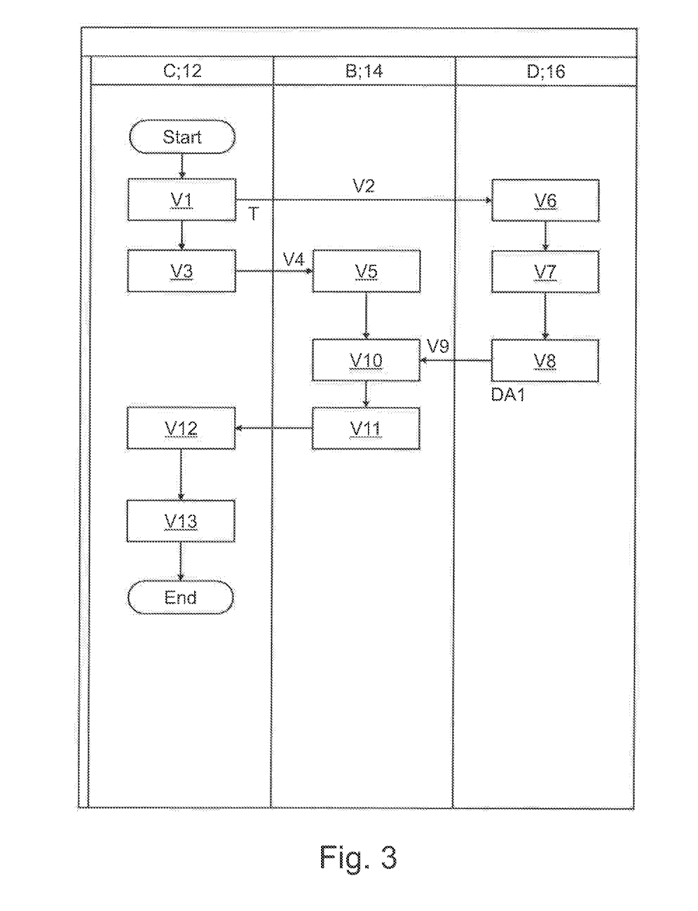

The identity inspection and assignment of an ID data record for a user C is performed by one of the connected identification service providers D (see FIG. 3). A possible identification service provider D can also be the service provider B itself. The data collected during verification of the identity of the user C are signed by the identification service provider D which performs it and then stored, encrypted with the public key of the user C, in the software application (app) A on the mobile device 12 of the user C.

The assignment of an ID data record to the application software A or the user C is shown in FIG. 3. The left column shows actions of the user C, the middle column actions of the identity service provider B and the right column the actions of an identification service provider C. The identity inspection and assignment of an ID record for a user C is performed by the following steps:
a) The process is started by the user C, by generating a transaction ID T (step V1) and communicating a transaction ID T generated by the application software (app) A and the user's public key (CPk) to the identification service provider D via an independent channel (digits or QR-Code);
b) The user C creates a data record for announcing the identification process (step V3) and to announce the determination of the identity (in a step V4), and using its application software (app) A sends to the identity service provider B a data record CA1 consisting of
   1. the hash value of the transaction ID T for assigning the transaction
   2. the public key (CPk) of the user C,
   3. the public key CPk of the user C encrypted with the transaction ID T,
   4. the last check digit Pz of the application software (app) A of the user C, and
   5. the signature of user C of the data record CA1;
c) The identity service provider (B) checks the signature and the check digit in step V5;
d) If the check digit is wrong, then an outdated copy of the digital security token is obviously being used by user C, i.e. the identity is compromised. Thereupon the identity service provider B immediately initiates appropriate emergency measures:
   i) disables the identity of C;
   ii) sends a signed disable message to the application software A in the terminal 12;
   iii) terminates the current transaction;
   iv) examines which transactions were made in the name of the user C between the outdated and the current check digit Pz and marks them as “potentially compromised”; and
   v) informs all identity recipients F, which have previously received a compromised identity data record of the user C, so that they can initiate appropriate measures as part of their risk management function;
   vi) In the event of a block, it is incumbent on the user C to get in contact with the identity service provider B to clarify the situation;
e) In step V6 the identification service provider D detects the transaction ID T provided by the user C, performs the determination of the identity of user C in step V7 and generates an ID data record DA (step V8), in which each field is individually signed by the identification service provider D;
f) In a step V9 the identification service provider D sends to the identity service provider B the data record DA1, consisting of:
   1. the hash value of the transaction ID T for assigning the transaction;
   2. the public key of D encrypted with the transaction ID T;
   3. the plain text ID data record encrypted with the public key CPk of the user C;
   4. the ID data record encrypted with the public key CPk of the user C, with the pure hash values of the individual data fields; and
   5. a signature of the identification service provider D of the data record;
g) In step V10 the identity service provider B examines the signature and stores the data record DA1 ready for retrieval by the user C by the user's application software (app) A (step V11). The correct assignment of the data is achieved by the transfer of the hash value of the transaction ID in both CA1 and in DA1;
h) At the next contact with the user C, the identity service provider B examines the current check digit Pz. If it is correct, the identity service provider B transmits the record BA1 to the application software (app) A of the user C (step V12) with
   1. the data record DA1,
   2. the public key of the identification service provider D,
   3. the quality class of the identification
   4. the signature of the identity service provider B of the data record.
i) The application software (app) A of the user C examines the data record BA1:
   1) are the signatures correct?;
   2) does the public key of the identification service provider D encrypted with the transaction ID T correspond to the unencrypted public key of the identification service provider D?
j) If the test is positive the application software (app) A stores the encrypted ID data record on the device 12 of the user C for future identification operations (step V13). The user C is now successfully identified and the assignment of the ID data record is terminated.

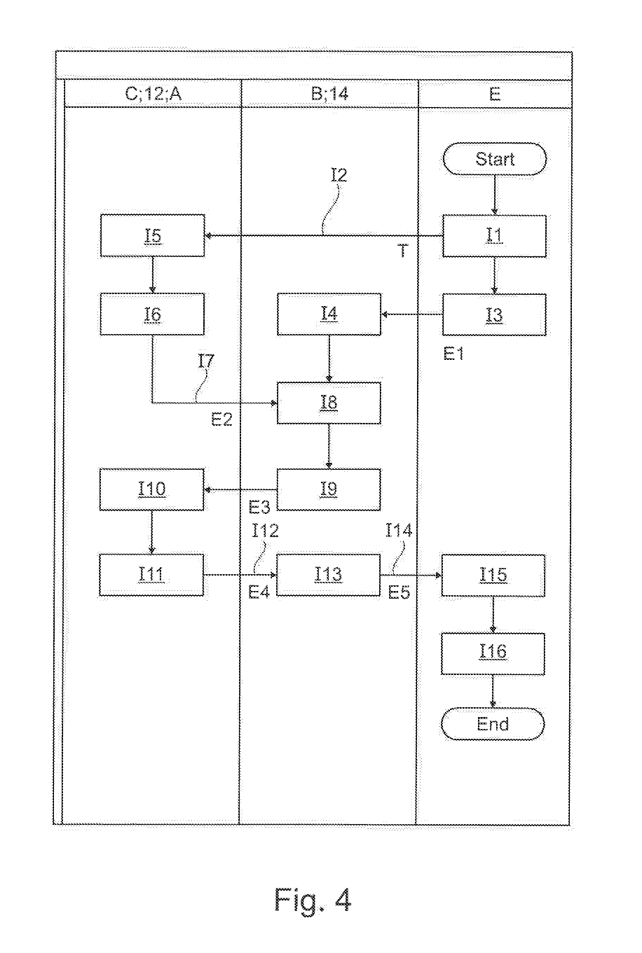

FIG. 4 shows a flow diagram of a remote identification. The safeguarding of the remote identification is very similar to the process of identity inspection from FIG. 3 by the connected identification service provider D and shows the general applicability of the security mechanisms of the method. The left column shows actions of the user C, the middle column actions of the identity provider B and the right column the actions of an identity recipient E.

The remote identification of the user C by an identity recipient E, such as a business partner required to provide identification, takes place via the identity service provider B:

a) The process is started by the identity recipient E (Start) communicating a transaction ID T generated in a step I1 to the user C and/or their app A via a visual display (digits or QR-Code) (step I2).

b) To announce the identification, in step I3 the identity recipient E sends to the identity service provider B a previously created data record E1, consisting of
1. a hash value of the transaction ID T for assigning the transaction,
2. a public key of the identity recipient E,
3. a public key of E encrypted with the transaction ID T,
4. a description of the requested data, and
5. the signature of the data record of identity recipient E.

The identity service provider B then verifies the authorization of the identity recipient in step I4.

c) In step I5 the user C records the transaction ID T provided by the identity recipient E with the app A, creates a data record E2 in step I6 to initiate the identification and sends the data record E2 to the identity provider B in step I7. This data record contains:
1. the hash value of the transaction ID T for assigning the transaction,
2. the last check digit Pz, and
3. the signature of user C of the data record.

d) The identity service provider B examines the signature and the check digit Pz and then verifies the validity of the identity provider, i.e. the user C, in step I8.

e) If the check digit is wrong, then an outdated copy of the digital security token is obviously being used by B, i.e. the identity is compromised. Identity service provider B
i) disables the identity of user C.
ii) sends a signed disable message to the application software A or the corresponding terminal 12,
iii) terminates the current transaction,
iv) examines which transactions were made in the name of the user C between the outdated and the current check digit and marks them as “potentially compromised”, and
v) informs all identity recipients E, who have previously received a compromised identity data record of the user C, so that they can initiate V appropriate measures as part of their risk management function.
vi) In the event of blocking, it is incumbent on the user C to get in contact with the identity service provider B to clarify the situation.

f) If the user C is known and is not blocked and the check digit Pz is correct, then in step I9 the identity service provider B sends a data record E3 to the user C. This includes:
1. The data record E1 previously sent by the identity recipient E to the identity service provider B;
2. The plain text name of identity recipient E;
3. A new check digit Pz; and
4. A signature of the identity service provider B of the data record.

g) Thereupon, the application software (app) A of the user C performs the following checks in a step I10:
i) Are the signatures of identity service provider B and identity recipient E correct?;
ii) Does the public key of recipient E encrypted with the transaction ID T correspond to the unencrypted public key of this recipient E?; and
(iii) Is the user C really willing to disclose the requested ID data to the identity recipient E?

h) In the case of consent by the user C, in a step I11 the app A decrypts the security token using the secret or the biometric feature of the user C, and in a further step 112 sends a data record E4 to the identity service provider B. This data set E4 contains:
1. the hash value of the transaction ID T for assigning the transaction;
2. the last check digit Pz;
3. the requested data items, ID data encrypted with the public key of the identity recipient E;
4. the public key of the recipient E encrypted with the transaction ID T;
5. the public key of identity recipient E; and
6. a signature of user C of the data record.

i) The identity service provider B examines the signature and the check digit Pz in a step I13. The error procedure is carried out in the same way as the previously mentioned point e).

j) If the user C is known and is not blocked and the check digit Pz is correct, then in step I13 the identity service provider B sends a data record E5 to the recipient E. This contains:
1. The data record E4 previously sent by user C to identity service provider B; and
2. A time-stamped signature of identity service provider B of the data record.

k) Identity recipient E receives the data record, examines and decrypts it in a step 15 and in a step I16, checks whether the transferred identification data are correctly signed.

As an alternative to the transmission of the identity data in plain text form, the request and transmission of the hash values are also possible. Thus, the recipient E can check the identity of the user C against a reference database, without the need for the identity data to be disclosed. In particular, in the case of pure matching against positive lists (membership file) or negative lists (blocked lists), this may be a great advantage from a data protection point of view.

The following advantages of the presented solution are obtained:

Generally available smartphones or other known data network terminals are used as carriers of a digital security token. Their associated digital ID can be transferred to another device by the legitimate owner, in other words the user C.

The solution can also be extended to the parallel use of a plurality of valid devices 12 under the control of the legitimate user C. This allows all devices 12 to be linked to the same person (the user C) and the respective apps to be used in parallel. This is of vital importance in the case of varying use of different device classes (tablet, smartphone, desktop PC, etc.) by the user.

The security level of the digital identity is variable and depends on the quality of the methods of identity collection and examination used, as well as the security level of the examined identity document. It is therefore possible for all levels to be mapped, from the lowest level based on pure self-identification of the user, up to the highest security levels, such as are required for identification when opening bank accounts. The identity service provider B in this case serves as a guarantor for the specified quality of the identity, because it must validate the linked identification service providers D with their methods accordingly.

Due to the parallel storage of the identity data both in plain text and in hashed form, a pseudonymous identity verification is possible without transmission of the data by matching the hash values.

A fraudulent use of the digital identity by third parties without the participation of the authorized person is rendered considerably more difficult:
The ID data are stored locally in encrypted form on the terminal 12 of the user C;
The key is protected with a dedicated password (or other user code) in the specially protected key-chain of the terminal 12;
Theft of the ID data requires the possession of the terminal 12 and the knowledge of the PIN of the terminal 12;
The use of the digital identity, however, additionally requires the knowledge of the password, with which the access to the key in the terminal 12 is protected;
Even in the event of a successful attack, however, an unauthorized use of the digital identity is also only possible for a limited period of time:
   (i) a few minutes, if the legitimate application software A for forming of the security token (in short: ID-app) is online;
   (ii) no later than the next legitimate use of the app A by the user C.
If unauthorized use is detected, subsequent unlawful identifications can be revoked retrospectively.

Overall, however, the solution offers an equivalent level of security to the eID function of the German identity card. Any improper disclosure of the digital identity by the authorized user C cannot be prevented by the method described, however.

Modifications and variations can be made to the embodiments illustrated or described herein without departing from the scope and spirit of the invention as set forth in the appended claims.

### LIST OF REFERENCE NUMERALS

Data network 10
Data network terminal 12
Server (identity service provider) 14
Server (Identification Service Provider/identity inspector) 16
Data network terminal 18
Application software A
Identity service provider B
User C
Public key of the user CPk
Identification service provider/identity inspector D
Client software identity inspector E
Identity recipient F
Test characteristic, dynamically changing Pz
Transaction ID T
Registration steps R1-R9
Assignment steps V1-V13
Identification steps I1-I16
Data records E1-E5
ID record DA1
ID token, identifying user UUID_C
ID token, identifying application software UUID_A

1-10: (canceled)

11. A method for operating a digital security token in a data network terminal (12), the digital security token useable for authenticating a user (C) on the data network terminal (12), the method comprising:
provisioning the digital security token in the data network terminal (12), the digital security token having a test characteristic (Pz), the test characteristic (Pz) stored in the data network terminal (12) and protected against unauthorized access by a user code, information about the test characteristic (Pz) and a connection of the test characteristic (Pz) to the data network terminal device (12) stored in a server (14) integrated into the data network (10);
examining the test characteristic (Pz) with the server (14) based on the information about the test characteristic (Pz) and the connection of the test characteristic (Pz) to the user (C) in the context of the use of the digital security token for authenticating the user (C) and/or in the context of a periodic routine examination; and
transmitting a new test characteristic (Pz) from the server (14) to the data network terminal (12) only if the examined test characteristic (Pz) is accurate, the new test characteristic (Pz) being necessary for continued operation of the digital security token.

12. The method of claim 11, further comprising disabling function of the digital security token with the data network terminal (12) and/or informing the user (C) of a possible improper use of the digital security token with the data network terminal (12) in the absence of confirmation of the accuracy of the examined test characteristic (Pz) by the server (14).

13. The method of claim 11, wherein the digital security token is a pure software token.

14. The method of claim 13, wherein the server (14) transmits the digital security token to the data network terminal (12).

15. The method of claim 11, wherein the user code is:
a password or other confidential piece of information known to the user; or
a biometric feature of the user.

16. The method of claim 11, wherein the test characteristic (Pz) is a check digit.

17. The method of claim 11, further comprising using the digital security token for a transaction using the data network terminal (12).

18. A non-transitory computer program comprising computer-executable instructions loaded in a memory of a data network terminal (12), the computer-executable instructions comprising:
provisioning a digital security token in the data network terminal (12), the digital security token having a test characteristic (Pz), the test characteristic (Pz) stored in the data network terminal (12) by a user code and protected against unauthorized access; and
examining a test characteristic (Pz) based on information about the test characteristic (Pz) and a connection of the test characteristic (Pz) to the user (C) in the context of the use of the digital security token for authenticating the user (C) and/or in the context of a periodic routine examination; and
transmitting a new test characteristic (Pz) from the server (14) to the data network terminal (12) only if the examined test characteristic (Pz) is accurate, the new test characteristic (Pz) being necessary for continued operation of the digital security token.

19. A data network terminal device (12) having a security token, the security token useable for authenticating a user (C) who is using the data network terminal device (12), the security token having a test characteristic (Pz), the test characteristic (Pz) stored in the data network terminal (12) and protected by a user code against unauthorized access, the data network terminal (12), configured to:
transmit the test characteristic (Pz) to a server (14) for examining the test characteristic (Pz) in the context of the use of the digital security token for authenticating the user (C) and/or in the context of a periodic routine examination; and
subsequently replace the examined test characteristic (Pz) with a new test characteristic (Pz) received from the server (14) for further operation.

20. The data network terminal device (12) of claim 19, wherein the data network terminal device (12) is configured to disable function of the examined digital security token and/or to inform the user (C) of a possible improper use of the examined digital security token in the absence of confirmation of the accuracy of the examined test characteristic (Pz) by the server (14).
